(19) United States
(12) Patent Application Publication
(10) Pub. No.: US 2008/0048410 A1
(43) Pub. Date: Feb. 28, 2008

(54) Bicycle tube connector

(76) Inventor: Chun-Hung Lin, Taichung Country (TW)

Correspondence Address: CHUN-HUNG LIN, 235 Chung - Ho, Box 8-24, Taipei, omitted

(21) Appl. No.: 11/507,251

(22) Filed: Aug. 22, 2006

(51) Int. Cl. B62K 13/06

(52) U.S. Cl. 280/209

(57) ABSTRACT

A bicycle tube connector is a hollow body formed by the coupling of a left shell and a right shell. The tube connector further comprises a transverse rotational shaft connected with two branches of a chain stay, a down tube hole for retaining an obliquely downward down tube. When the bicycle tubes are connected within the tube connector, the left and the right shells are soldered together along the engaged border therebetween. Therefore, the various tubes of the bicycle are more firmly secured and the outlook of the bicycle frame is slick.

### FIELD OF THE INVENTION

The present invention relates to the bottom bracket structure of a bicycle, more particularly to a bicycle tube connector that can enhance the stiffness of a bicycle frame and maintain the slick outlook of the bicycle.

### BACKGROUND OF THE INVENTION

The bottom bracket of a bicycle, which links the seat tube, the down tube and the chain stay, is where the gravity of the loading and the reactive ground force converge. Those tubes are conventionally connected by a multiple connecting tube and soldered therein, which has the following disadvantage:

1. Making the outlook of a bicycle frame less smooth: The various converged to the multiple connecting tube are secured by soldering around the circular contact surfaces. Therefore, the soldering tracks will bulge, and therefore the outlook of the structure around the multiple connecting tube will become less smooth.

2. Making the tube connections less stiff: The various converged to the multiple connecting tube are secured by soldering around the circular contact surfaces. Therefore, the soldering is less stiff, which may cause disintegration of the structure around the multiple connecting tube.

3. Making the structure around the multiple connecting tube less ease: Due to the complexity in the connections with the seat tube, the down tube and two branches of the chain stay, the spacing between various tubes about the multiple connecting tube is small. When the multiple connecting tube is contaminated by dirt or mud, it is difficult to be cleaned.

The above disadvantages need to be overcome, which motivates the present invention.

### SUMMARY OF THE INVENTION

The primary objective of the present invention is to provide a bicycle tube connector by which the down tube, the chain stay and other tubes of a bicycle may firmly connected.

The secondary objective of the present invention is to provide a bicycle tube connector which will make the outlook of the bicycle frame more visually appealing.

It is a further objective that a bicycle equipped with the present invention will become lighter.

The various objects and advantages of the present invention will be more readily understood from the following detailed description when read in conjunction with the appended drawings.

### BRIEF DESCRIPTION OF THE DRAWINGS

FIG. 1 is an exploded perspective view of a bicycle tube connector of the present invention.

FIG. 2 is a perspective view of the bicycle tube connector in FIG. 1.

FIG. 3 is another exploded perspective view of the bicycle tube connector in FIG. 1.

FIG. 4 is the bicycle tube connector in FIG. 1 installed in a bicycle frame.

FIG. 5 is an exploded perspective view of the second preferred embodiment of the present invention as a bicycle tube connector.

FIG. 6 is a perspective view of the bicycle tube connector in FIG. 5.

FIG. 7 is an exploded perspective view of the third preferred embodiment of the present invention as a bicycle tube connector.

FIG. 8 illustrates a connecting means of the bicycle tube connector in FIG. 7.

FIG. 9 is a perspective view of the bicycle tube connector in FIG. 7.

FIG. 10 illustrates another connecting means of the bicycle tube connector in FIG. 7.

FIG. 11 is fourth preferred embodiment of the present invention as a bicycle tube connector installed in a bicycle frame.

FIG. 12 is a perspective view of the bicycle tube connector in FIG. 11.

FIG. 13 is fifth preferred embodiment of the present invention as a bicycle tube connector installed in a bicycle frame.

FIG. 14 is a perspective view of the bicycle tube connector in FIG. 13.

### DETAILED DESCRIPTION OF THE PREFERRED EMBODIMENTS

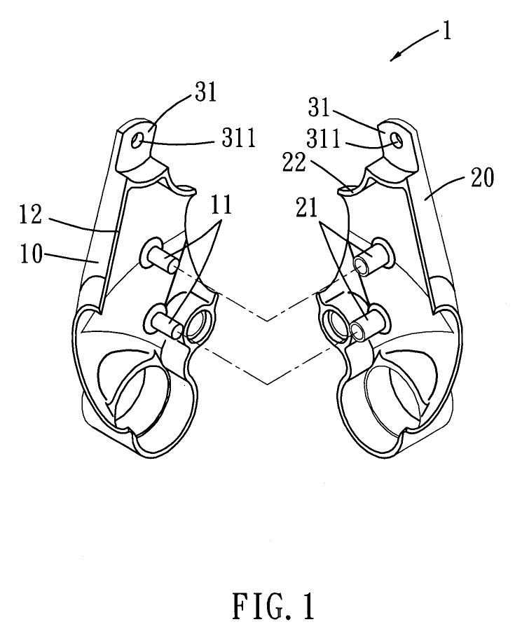

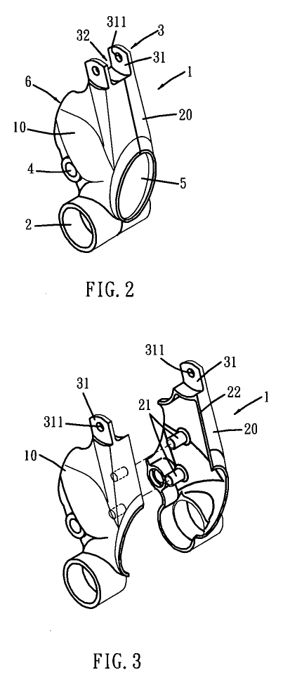

Referring to FIGS. 1 to 3, a tube connector 1 at a bicycle bottom bracket according to the present invention comprises a pair of opposite faced left shell 10 and right shell 20. The left shell 10 and right shell 20 are engaged with each other to form a hollow body. The connection of the left shell 10 and the 20 are achieved by solid posts 11 on the inner wall of the left shell 10 and the corresponding hollow posts 21 on the inner wall of the right shell 20. As the left shell 10 and the right shell 20 are being coupled, the solid posts 11 will be inserted into the hollow posts 21.

The left and right shells 10, 20 has a crank axle hole 2 on the bottom portion thereof for a crank axle to go through, a shock absorber mount 3 on the top side thereof, a tubular rotational shaft 4, a bottom tube hole 5 and a seat tube hole 6. The shock absorber mount 3 further includes a pair of ears 31 with coaxial through holes 311 and a receptacle 32. The rotational shaft 4 is parallel to the crank axle hole 2, which is connected to the chain stays. The down tube hole 5 is located close to the crank axle hole 2, and the seat tube hole 6 is located close to the rotational shaft 4.

The left shell 10 and the right shell 20 of the tube connector 1 at a bicycle bottom bracket are easy to combine. Since the interior is a hollow space, the tube connector 1 is light.

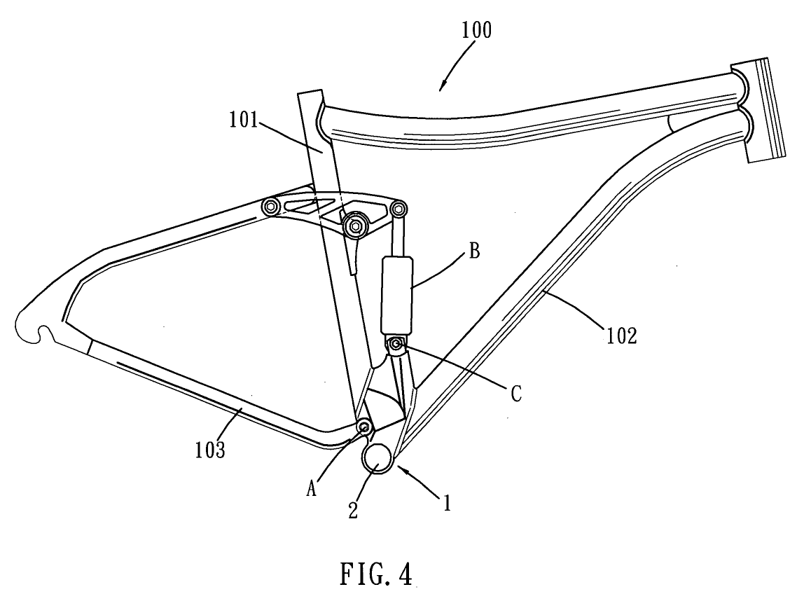

Further, the advantages of the bicycle tube connector installed in a bicycle structure will be explained in FIG. 4.

The bicycle frame 100 has a plurality of tubes that will converge to the tube connector 1. The crank axle linked to the pedals will go through the crank axle hole 2. The seat tube 101 of the bicycle frame 100 will be inserted into the seat tube hole 6 and locked over there by welding. The down tube 102 will obliquely inserted into the seat tube hole 6 and again locked over there by welding. The chain stay 103 has its left and right branches respectively connected to two ends of the rotational shaft 4; a shaft a goes through the rotational shaft 4 to achieve a pivotal connection. The bicycle frame 100 further includes a shock absorber b. The shock absorber b has one end retained in a receptacle 32 between the ears 31 on the top of the shock absorber mount 3. A locking part c is inserted into the through holes 3 11 on the ears 3 1 for locking the connecting end of the shock absorber b.

The tube connector 1 at a bicycle bottom bracket provides a crank axle hole 2, a down tube hole 5 and a seat tube hole 6 respectively connected to a crank axle, a down tube 102 and a seat tube 101. The connected slits are sealed by soldering the tubes and the holes together, which is more reliable than the soldering in the structures of the prior art. Since the seat tube 101 and the down tubes 102 are partly inserted into the corresponding holes on the tube connector 1. The soldering tracks will therefore naturally follow the seal slits between the tubes and the holes on the tube connector 1, leaving the bicycle frame 100 and the tube connector 1 more visually appealing.

The chain stay 103 and shock absorber b are connected to the tube connector 1 respectively by the rotational shaft 4 and a locking part across the shock absorber mount 3. Therefore, the outlooks of the bicycle frame 100 and the tube connector 1 appear smooth. Further, the transverse rotational shaft 4 that connects the chain stay makes the connection between the tube connector 1 and the chain stay 103 stiffer and more sustainable to the reaction force from the ground when the bicycle is jumping.

It should be noted that the spacing between the tube connector 1, the seat tube 101, the down tube 102 and the chain stay 103 is larger, and therefore it is easier to clean the dirt and mud attached to the tube connector 1 and the surrounding tubes. Because of its hollow structure, the bicycle thereby formed will be lighter.

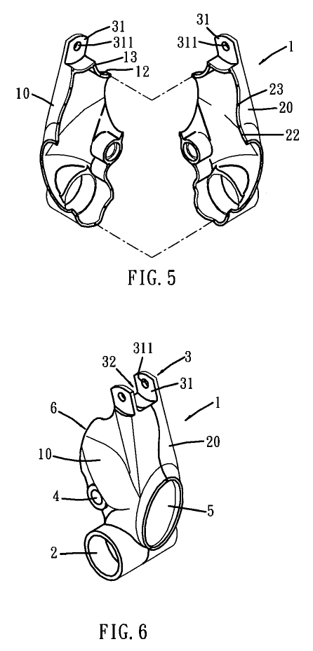

Referring to FIGS. 5 and 6, the second preferred embodiment of the present invention is feature by a plurality of connecting holes 13 formed on the first lateral surface 12 of the left shell 10 and a plurality of pins 23 on the second lateral surface 22 of the right shell 20. When the left and the right shells 10, 20 are combined, the connecting holes 13 and the pins 23 are coupled together, forming the hollow tube connector 1.

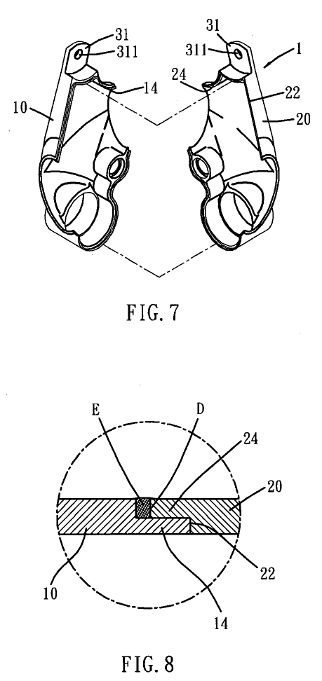

Referring to FIGS. 7 and 8, the third preferred embodiment of the present invention is feature by an elongated projected side 14 extended along the bottom edge of a first lateral surface 12 around the left shell 10 and an elongated recessed side 14 of an elongated recessed side 24 extended along the bottom edge of the right shell 20, whereby the elongated projected side 14 and the elongated recessed side 24 will engage with each other as the left shell 10 and the right shell 20 are combined. There is a solder groove d formed along the engaged border of the elongated projected side 14 and elongated recessed side 24 for retaining solder e, which will make the engaged border smooth and slick, therefore making the bicycle frame 100 more visually appealing.

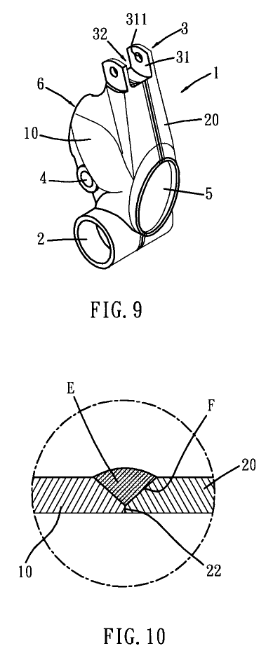

Referring to FIGS. 9 and 10, the third preferred embodiment of the present invention has a different structure of engagement between the left shell 10 and the right shell 20, wherein the edges of engagement of the first lateral surface 12 and the second lateral surface 22 form two obliquely cut surfaces f. When combined, the obliquely cut surfaces f form a groove of V-shaped cross section that will be filled with solder for welding the left shell 10 and the right shell 20 together.

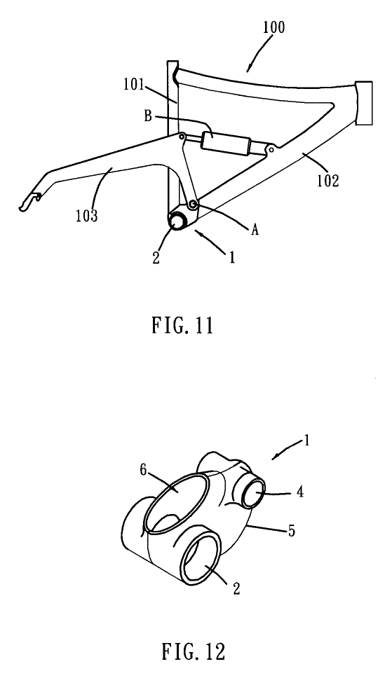

Referring to FIGS. 11 and 12, the fourth preferred embodiment of the present invention is used with a bicycle having a horizontal shock absorber b. Therefore, a shock absorber mount is omitted. Other functions of the tube connector 1 are the same as the previous preferred embodiments.

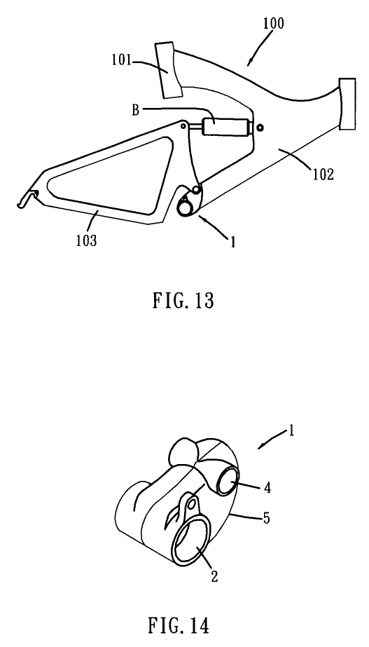

Referring to FIGS. 13 and 14, the fifth preferred embodiment of the present invention is used with a bicycle without a seat tube. Therefore, a seat tube hole and a shock absorber mount are omitted. Other functions of the tube connector 1 are the same as the other preferred embodiments.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle tube connector, comprising:
a left shell;
a right shell capable of connecting said left shell to from a hollow body;
a transverse hollow crank axle hole on a bottom side of said tube connector;
a transverse rotational shaft going through said tube connector located at a predetermined location; and
a down tube hole located close to said crank axle hole for receiving a bicycle down tube.

2. The bicycle tube connector of claim 1 wherein said tube connector further comprises a seat tube hole closer to said rotational shaft and connected to said down tube hole.

3. The bicycle tube connector of claim 1 wherein said tube connector -further comprises a top shock absorber mount.

4. The bicycle tube connector of claim 3 wherein said shock absorber mount is formed by two parallel ears extended from a top wall of said left shell and said right shell; said ears respectively having coaxial through holes; said ears defining a receptacle therebetween.

5. The bicycle tube connector of claim 1 wherein said left shell and said right shell are connected by the engagement between boundary projected wall and boundary depressed wall respectively around said left shell and said right shell.

6. The bicycle tube connector of claim 2 wherein said left shell and said right shell are connected by the engagement between boundary projected wall and boundary depressed wall respectively around said left shell and said right shell.

7. The bicycle tube connector of claim 5 wherein said left shell and said right shell are connected by the engagement between insertion posts and hollow receiving posts respectively on inner walls of said left shell and said right shell.

8. The bicycle tube connector of claim 6 wherein said left shell and said right shell are connected by the engagement between insertion posts and hollow receiving posts respectively on inner walls of said left shell and said right shell.

9. The bicycle tube connector of claim 5 wherein said left shell and said right shell are connected by the engagement between pins and connecting holes respectively on lateral contact surfaces of said left shell and said right shell.

10. The bicycle tube connector of claim 6 wherein said left shell and said right shell are connected by the engagement between pins and connecting holes respectively on lateral contact surfaces of said left shell and said right shell.

11. The bicycle tube connector of claim 5 wherein said left shell and said right shell are connected by the engagement between an elongated long skirt section and an elongated short skirt section respectively around said left shell and said right shell; the combination of said elongated long skirt section and said elongated short skirt section forming a solder groove for retaining a solder material.

12. The bicycle tube connector of claim 6 wherein said left shell and said right shell are connected by the engagement between an elongated long skirt section and an elongated short skirt section respectively around said left shell and said right shell; the combination of said elongated long skirt section and said elongated short skirt section forming a solder groove for retaining a solder material.

13. The bicycle tube connector of claim 5 wherein said left shell and said right shell are connected by the engagement between a localized oblique cut surface and another symmetric localized oblique cut surface respectively around said left shell and said right shell; the combination of said obliquely cut surfaces forming a solder groove with V-shaped cross section for retaining a solder material.

14. The bicycle tube connector of claim 6 wherein aid left shell and said right shell are connected by the engagement between a localized oblique cut surface and another symmetric localized oblique cut surface respectively around said left shell and said right shell; the combination of said obliquely cut surfaces forming a solder groove with V-shaped cross section for retaining a solder material.
